(19) United States
(12) Patent Application Publication
(10) Pub. No.: US 2003/0187939 A1
(43) Pub. Date: Oct. 2, 2003

(54) Sender-initiated print-on-receipt fuctionality in an electronic messaging environment

(76) Inventor: Peter T. O'Brien, West Vancouver (CA)

Correspondence Address: Peter T. O'Brien, 1253 Keith Road, Vancouver, BC, V7T 1N1, CA

(21) Appl. No.: 10/361,754

(22) Filed: Feb. 11, 2003

Related U.S. Application Data
(60) Provisional application No. 60/355,817, filed on Feb. 13, 2002.

(51) Int. Cl. G06F 15/16

(52) U.S. Cl. 709/206; 709/236

(57) ABSTRACT

This invention discloses a method and system whereby a conventional electronic mail system is enhanced to add functionality to allow the sender of an e-mail message to insert a “print-on-receipt” (P-O-R) flag or code in an e-mail message and for the receiving e-mail system to detect the flag and print the e-mail without any user intervention. In the preferred embodiment, the receiving e-mail system composes and sends a affirmative feedback reply message to the sender to indicate that the original message was successfully printed. Further enhancements are described to add functionality to control the acceptable message sizes and to filter and control the processing of incoming of P-O-R e-mail to avoid unwanted messages being printed without user intervention. Further enhancements are described to print files attached to the P-O-R e-mail message. Further enhancements are described whereby the receiving e-mail system composes and sends an appropriate negative feedback message when the system is unable or unwilling to print the message upon receipt.

### CROSS-REFERENCE TO RELATED APPLICATIONS

This application to supercede Provisional Application Serial No. 60/355,817 filed Feb. 13, 2002.

### FEDERALLY SPONSORED RESEARCH OR DEVELOPMENT

Not applicable

### BACKGROUND OF THE INVENTION

The present invention relates to electronic messaging systems and methods, and more particularly relates to a system and method whereby the sender of an e-mail message may include a print-on-receipt request in an e-mail message, and a system and method whereby the receiver's e-mail program will recognize said request and print a hard copy of the e-mail as soon as it is received, without operator intervention, and the receiver's e-mail program will provide a feedback message to the sender indicating that the receiver's e-mail program has successfully printed the message or has failed to print the message. The invention includes associated message-processing methods and system suitable for implementing such functionality. E-mail systems and functionality have been in existence for many years, so their normal functions will only be briefly reviewed. Data in the form of e-mail is transferred between personal computers via a communication network system such as the Internet. Generally, the sender uses an e-mail program such as Microsoft Outlook, Outlook Express, Eudora, Lotus Notes, Lotus ccMail, AOL or Netscape to compose and transmit (“send”) the e-mail data. The receiver uses the same or similar e-mail program on his computer to receive the e-mail data. The receiver may issue an explicit request to the e-mail server or the e-mail program may be configured to automatically issue a request to the e-mail server to periodically download any awaiting messages. In either event, the incoming e-mail is typically stored on the receiver's computer storage device (“hard drive”) in a directory (“inbox”, “new mail”, “folder”, or “mail box”) dedicated for this purpose within the receiving end computer.

Generally, the standard used by most commercial off the shelf (COTS) e-mail systems to define the structure and content of e-mail messages, and in particular the contents of the e-mail header, is called the Simple Mail Transfer Protocol (SMTP).

The Messaging Application Programming Interface (MAPI) is a standardized set of C programming functions that may be placed into a code library known as a Dynamic Link Library (DLL). The MAPI functions were originally designed by the Microsoft Corporation, but they have received support of many third party vendors. Since MAPI standardizes the way messages are handled by mail-enabled applications, each such application does not have to include vendor-specific code for each target messaging system. In particular, the MAPI features facilitate the addition of new properties. This is accomplished by calling the appropriate MAPI function, SetProps, and providing the name and value of the new property. The properties are saved as part of the message item. Additional information is available in the MAPI specification.

With the advent of dedicated high-speed Internet connections, more and more e-mail users now have their computers connected full time to the Internet, and their e-mail programs are running constantly, checking for mail on a regular basis, and downloading it from the e-mail server to which the user subscribes without operator intervention.

In current e-mail programs, the receiver typically must manually instruct the e-mail program to display each e-mail message on the computer's screen. Similarly, if the receiver requires a printout (“hard copy”) of the e-mail message, he or she must manually instruct the e-mail program to format and send the data (i.e. the e-mail message) to a printer connected to the receiver's computer. The problem is that in current e-mail programs user intervention is generally required in order to print e-mail.

By contrast, it is well understood that on-receipt printing is an ordinary characteristic of telefax (“fax”) machines. In the event of an error on the receiver's fax machine, the feedback signal contains the error code or description (e.g. “Connection failed” or “Out of paper”). The sender's fax machine in such event typically prints an error message, and may, if so programmed, try to re-send the digitized document image some number of times. Although sender-controlled printing is not a standard characteristic of fax machines, the sender is reasonably certain that unless an error signal is received from the receiving fax machine (or system), a facsimile of the transmitted document was printed at the receiving end.

There exist several software systems installable in computers that enable the computers so equipped to receive telefaxed (“faxed”) documents, by using a modem or equivalent to communicate via the public telephone network directly with the sending fax machine or computer sending the faxed document. For example the fax software programs WinFax Pro and FaxNow! 2000 enable the computer to receive a faxed document transmission by enabling the receiving computer via its modem or equivalent to answer the ringing phone line, receive the faxed document(s) and save the digitized received documents on the computer's hard disk storage. These programs can typically be set up or user-directed to print the incoming faxed document upon receipt without human intervention.

In such a system, when fax software is used in place of dedicated fax machine to receive a fax, the sender may not receive an error message if the document sent failed to be printed. The large majority of fax machines cannot print in color, so only black and white images are generally rendered on the receiver's fax machine or computer printer. Another problem with using faxed documents is that the sender must use the public telephone network which may be more expensive and slower than e-mail systems. A further limitation of fax machines, and even bulk fax transmitting systems is that they must dial one destination fax number at a time.

There exist several software systems that can convert fax-format documents to e-mail messages. For example, the eFax Delivery Network provides a dedicated eFax Plus fax number to its subscribers. When a faxed document is received via the public telephone network for the subscriber, this system converts the faxed document to an e-mail attachment and sends the document by e-mail to the subscriber as an attached electronic file. However, if the receiver wants a hard copy (printed copy), he must instruct his e-mail program to print the attachment. To utilize such a system, the sender must subscribe to the fax-forwarding service. In such a system, when e-mail software is used in place of dedicated fax machine to receive a fax, the sender may not receive an error message if the document sent failed to be printed. Furthermore, such systems generally do not provide “print-on-receipt” functionality.

On many occasions a computer user will compose a document and format it using a word processor or page makeup software, print a hard copy, and then proceed to fax it to the intended recipient. The problem is that the user wants to ensure that the recipient receives a hard copy of the document, but there is typically no simple means available to achieve this by using e-mail capabilities of such software, other than to send to a fax number.

PaperClip Software, Inc. sells a software system called Internet Express (IE). This is an example of an Internet-based electronic document package delivery service designed to interconnect trading partners using its Integrated Document Management Solutions software. IE transports electronic document packages across the IE SSL communication network, eliminating the need to scan. It utilizes the public standard Electronic Document eXchange v2.0 for packaging electronic documents. Two computers using the EDX v2.0 compliant system can connect via the IE Server, which can be configured to print the document or a TIFF image (without human intervention) when the documents arrive at the IE Server. The specific problem with such a system is that both the sender and the receiver must cooperate to a great extent, by subscribing to a specialized electronic messaging service, and by implementing complementary software at the sending and receiving stations. Generally, e-mail users would not have such specialized software installed on their computers.

There exist patents disclosing methods for remote printing across a wide area network to a specific printer at the receiving end, and in particular for remote printing utilizing e-mail as the medium to transfer a file containing print data to a receiving system that can print the file in text and graphical formats at the receiving station. For example U.S. Pat. No. 6,160,631 describes a system where a word processing operator for example could select a print command for the document being edited, and specify a remote printer rather than a local printer. This invention is comprised of a customized print driver on the sender's system that intercepts printer data, packages said printer data into “print mail” using a non-standard e-mail header data structure that includes the file format and other printer specific information, and sends the printer data by e-mail to a unique e-mail receiving system that can identify the remote print request, and print the print file on receipt on a known printer on the receiver's system.

U.S. Pat. No. 6,466,328 describes a similar system that utilizes the File Transfer Protocol (FTP) to transmit the print file to the remote printer.

The specific problem with such systems is that both the sender and the receiver must cooperate to a great extent, by implementing a specialized print driver at the sending station, and by implementing non-standard e-mail sending and receiving systems. Generally, e-mail users would not have such specialized software installed on their computers.

Some e-mail systems, such as Microsoft Outlook (from the Microsoft Corporation) used to have the capability of executing attached programs upon receipt, which could in theory provide a sender-initiated means of printing upon receipt. The problem with this execute-on-receipt capability is that it can be exploited by hackers and “virus” programs to perform system commands, consequently, e-mail software manufacturers have generally removed this capability from their products.

At present, e-mail systems such as Microsoft Outlook provide a means whereby the receiver may use configurable parameters (“rules”) to instruct the system to print incoming e-mail upon receipt, using on a variety of criteria based on the e-mail header information or keywords in the body of the message. To utilize this capability to implement sender-initiated print-on-receipt functionality, the sender and receiver would have to cooperate in implementing the receiver's rules in the sent message. The problem is that there is no way the sender can request print-on-receipt when a message is sent to a recipient that is unknown to the sender, i.e. where the sender knows only the recipient's e-mail address and knows nothing about the recipient's e-mail system or its configuration.

Some vendors such as MK Net.Work have produced so called “MAPI Agents” or “plug-ins” which utilize MAPI capabilities to extend the functionality of the COTS e-mail systems, such as Microsoft Outlook, Lotus and Eudora. These program code modules can provide additional features such as processing rules for incoming e-mail. There is no evidence in the prior art in this area that such vendors have implemented sender-initiated print-on-receipt functionality in their products.

There are software systems (such as Banter) that can parse keywords from an incoming e-mail message and compose and send an automated reply to the sender based on the subject matter of the incoming e-mail message. There is no evidence in the prior art in this area that such vendors have implemented feedback messages relating to the success or failure of a print-on-receipt request in their products.

In summary therefore, the prior art has not provided any convenient or effective way for a standard, COTS electronic messaging system (and in particular e-mail systems) to emulate some of the functionality of a fax machine such as print-on-receipt and “guaranteed delivery” of a hard copy (printed copy) of the transmitted document(s). That is, to provide a means for the sender of an e-mail message to include a print-on-receipt request, and for the receiving e-mail systems to process the request and print the incoming message without operator intervention, and further to provide a feedback message, all without introducing changes to the data structure of the standard e-mail message header that would make the message incompatible with standard (e.g. SMTP) e-mail processing systems.

The prior art has not provided any convenient or effective way to allow the sender of an electronic message (and in particular an e-mail message) to make a print-on-receipt request without the need for the sender to have any knowledge of the receiver's computer system or configuration other than the receiver's e-mail address.

### BRIEF SUMMARY OF THE INVENTION

The present invention satisfies the above described needs and addresses the above described problems by providing such sender-initiated print-on-receipt functionality both in method and apparatus terms. Methodology is preferably included at the sending station to allow the sender to modify the coding used in e-mail messages to include at the very least a print-on-receipt request in the sent message and preferably other coding such as automatic acknowledgment by the receiver's printing station that it has completed or at least initiated the printing of the transmitted message or negative feedback from the receiver's printing station indicating that it is unable to satisfy the print-on-receipt request.

Treatment of attachments to e-mail messages is optional; of course some attachments such as executable files cannot be printed, but text attachments created by word processing software or an electronic document format such as Portable Document Format (PDF), as well as files or image attachments created by scanning devices for example, could be printed at the request of the sender, subject to appropriate regulation by the receiving station.

In apparatus terms, a suitably programmed general-purpose computer with suitable connectivity to a wide area network such as the Internet, an Intranet or a local area network can be used both for transmission and reception purposes. Assuming that the programming and the message coding protocols are suitably selected, no special-purpose equipment is required. The printer used at the receiving station can be the one normally used by the computer to print messages when directed by the receiver, or it can be another printer connected to the receiver's computer (via a local area network for example) that is specially designated to print incoming print-on-receipt e-mail messages.

Preferably, related functionality may be included to enable the receiver to filter incoming e-mail messages and control the response to a print-on-receipt request, for example to provide the receiver with the means at the receiving station to suppress or reject the request, on a particular e-mail account, from all senders, or from selected senders, or from all but selected senders. Further capability may be included to enable the sender to configure parameters to control the sending of e-mail.

Applications and Benefits of the Invention

The “print-on-receipt” (hereinafter referred to as “P-O-R”) functionality of the invention can be applied or added as an improvement to many different kinds of electronic message transmission systems, and in particular e-mail transmission systems, and applications that can send e-mail, including without limitation ordinary interpersonal and intra-corporate e-mail systems, accounting systems, e-mail fax delivery systems, and pathology laboratory results distribution systems. The P-O-R functionality of the invention can be applied or added to many different kinds of e-mail reception systems, including without limitation ordinary interpersonal and intra-corporate e-mail systems, and e-mail servers.

The principal advantage of the P-O-R functionality is that a sender-initiated P-O-R e-mail messages can be printed without human intervention by the receiver. Accordingly, without human intervention by the receiver, after reception, a “hard copy” of the document or message is waiting in the printer out tray for the receiver to read.

Printed matter appears to imply a greater sense of urgency, and thus the receiver may if desired read the printed message before checking incoming e-mail on the display screen of the receiver's computer. At present, if the e-mail recipient is not at their receiving station (e.g. out of the office) and e-mail is received, an urgent message may be ignored. By using the P-O-R functionality, a hard copy of the message will be on the printer and may be read and responded to by another person.

Note that while the P-O-R functionality affords many of the benefits of faxing, potential savings on long distance telephone transmission charges exist, as compared to using a fax machine. Another advantage of using P-O-R e-mail is that, unlike a fax machine using a telephone network, the receiving station is never “busy”, so the need to re-send the message is reduced. Unlike faxed documents, P-O-R e-mail may be sent to a plurality of recipients at once by using a group or list of contacts.

Note also that even though the incoming message will have been printed by reason of the P-O-R functionality, nevertheless an electronic copy of the message will also have been stored in, and is readily retrievable from, an e-mail in-box (or new mail) folder for future reading on the computer screen.

The need to send a document containing graphics and advanced text formatting can be satisfied using the generally available feature of modern e-mail systems (and some word processing systems) to compose and send outgoing e-mail wherein the body of the e-mail message can be formatted with graphics and advanced text formatting (e.g. HTML). Using P-O-R e-mail, the document could also be printed, with the formatting intact, at the receiver's computer without user intervention.

Note that bulk messages may be composed and transmitted via the Internet. For example some accounting systems implemented on computers attempt to save costs, in the labour required to stuff printed documents into envelopes and the cost of postal service stamps by composing e-mail messages containing invoices or statements of account which are sent via e-mail to a large number of customers. P-O-R e-mail could offer the additional capability of knowing that the recipient has received a “hard copy” of the invoice or statement. P-O-R e-mail would be simpler to implement than the current computer-to-computer invoicing systems using Electronic Data Interchange (EDI), and would appeal to small- to medium-sized corporations. Effective use of a P-O-R e-mail system could result in reducing postage expense and in collecting receivables more rapidly.

Note that in future, from time to time conventional mail may have to be sterilized at the mail sorting stations to counter a threat of infectious matter sent via the mail. By replacing conventional mail with P-O-R e-mail, there may be a reduction of the postal workers' workload and personal risk.

Using P-O-R e-mail, various types of feedback may be provided by the receiving station to the sending station. For example, the receiving station may provide a “Printed OK” feedback message to the sending station once printing has been initiated or effected.

Note that since P-O-R apparatus and methodology have the ability to deliver a printed message to a receiver who does not have a fax machine, the general need for owning fax machines can be reduced, provided that both sender and receiver are inter-connectible via a suitable network for the transmission and reception of digital messages (including digitized documents) and both sender and receiver have implemented one of the popular e-mail systems incorporating some or all of the functionality of this invention.

Note also that if the original document to be transmitted is itself a hard copy, and if the sender has a scanner connected to his computer, he can perform the scanning function of a fax machine by scanning the paper document and sending it as an electronic file, e.g. as a .jpg or .pdf or .tiff file either embedded in the body of the e-mail message (e.g. using HTML) or as an attachment to a cover e-mail message.

Further, the P-O-R apparatus and methodology of the invention are not limited, as are most fax machines, to black-and-white versions of graphics or formatted text; colored images may be transmitted and printed in color if the receiving station is equipped to print in color.

In another conceivable implementation, bulk-mail sales orders submitted by customers or traveling sales representatives using P-O-R e-mail could be received and printed at the corporate offices of the intended receiver of such orders, to expedite or facilitate order-processing.

In other conceivable implementations, statements, news releases, newsletters, school records, and any other application currently served by bulk telefaxing services or conventional mail could be implemented effectively and relatively cheaply by e-mail incorporating P-O-R functionality.

In another conceivable implementation, P-O-R e-mail could be automatically generated from a computer based pathology laboratory results system, and the results sent to the e-mail address of the attending physician, the patient's personal physician, any specialist physicians treating the patient, the patient's insurance company or HMO, and/or the hospital ward in which the patient resides. This could expedite the simultaneous transmission of a “hard copy” of lab test results to all stakeholders and possibly improve the outcome of the patient treatment.

In other conceivable implementations, physician's reports, radiography images and medical records could be sent between health care professionals using P-O-R functionality. The P-O-R receiving e-mail system would automatically generate a “hard copy” of such records to be placed in the patient's file.

In organizational environments (such as the U.S. Patent Office) in which it is the policy of the organization to print and retain all official e-mail, the sender could be instructed to always use P-O-R functionality when appropriate, to reinforce the understanding of the receiver that a hard copy of the e-mail message is to be retained and filed by the receiver.

In project work in which messages are passed between the members of a project team, as, for example, between contractor and sub-contractor, or between the customer and the contractor, P-O-R functionality could be used to generate a hard copy of formal e-mail messages to be filed as part of the official project record.

In some organizations, there is a policy that all e-mail messages shall be deleted and erased from the system after a certain time. In these types of organizations, if important e-mail is sent as P-O-R, then the chances of having an important message or document inadvertently lost is reduced, because a hard copy was produced upon receipt.

It is therefore the object of the present invention to satisfy the above described needs by providing an improved system and method for sender-initiated print-on-receipt capability within an electronic messaging system, and more particularly within an e-mail messaging system that can utilize COTS e-mail software and standard message formats.

The present invention in both method and apparatus aspects forms part of an e-mail transmission/reception system and accordingly has both transmission and reception aspects. The present invention may be considered as a set of modifications of an otherwise conventional e-mail transmission, reception and printing facility.

According to the invention, the sender or sending application may assign a P-O-R code or “flag” or category, or other suitable property of the e-mail message that may be uniformly or selectably included in an e-mail message at the sending station. The detection of the P-O-R flag at the receiving station prompts the receiving station to print the received message without operator intervention.

Receiving Station

At the receiving station of the system, the receiving computer system is capable of receiving e-mail messages containing a P-O-R request sent from the sending computer system via a communication line (such as the Internet) and printing such e-mail messages without human intervention.

In one embodiment of the invention, user configurable parameters may be implemented to allow the receiver to filter incoming e-mail messages and control the response to P-O-R requests. For example, the receiver system may be instructed to print all messages for a specific sender or to print all messages received on specific e-mail account maintained by the recipient specifically for P-O-R e-mail. The benefit of this functionality is that the receiver may give the P-O-R enabled e-mail address to those parties they are willing to receive P-O-R message from. If they chose to discontinue receiving P-O-R messages they can close or delete the enabled account and not disrupt the incoming flow of normal e-mail on their other accounts. Further, by utilizing additional configurable parameters, the receiver may instruct the receiving e-mail program to reject P-O-R messages over a total byte size, or to reject P-O-R messages larger than a specified number of printed pages.

Further, by utilizing additional configurable parameters, the recipient may instruct the receiving e-mail program whether to use the default printer available to the recipient's computer or to use a specially designated printer for all P-O-R messages to be printed.

Sending Station

Conventional e-mail messages sent on the Internet carry header information such as a routing code, a transmitter identification code, the sender's e-mail address and reply address, and a message priority code and/or a message importance code. The routing code includes a digitized version of the receiving station's e-mail address and enables the message to be dispatched to the designated receiver.

Among other possible enhancements of the inventive P-O-R system herein described, the sending station (i.e. the sender's e-mail system) may be provided with the following functionality:

The preferred embodiment of the invention provides additional functionality to the e-mail program such as a graphical user interface or other means for the sender to insert a flag or assign a property or attribute to the outgoing message to indicate a P-O-R request.

In the preferred embodiment of the invention, when a P-O-R request is made by the sender, the sender's computer system is capable of sending e-mail messages carrying P-O-R code to one or more other designated computer systems via the selected communication line or network (such as the Internet).

In one embodiment of the invention, user configurable parameters may be implemented to allow the sender to control the sending of P-O-R e-mail and the responses to P-O-R feedback messages from the receiver system. In another embodiment of the invention, the sender's e-mail system may store a flag in each contact record (e.g. in the address book) to signify that the contact accepts P-O-R requests. This could act as a reminder to the sender not to make a P-O-R request for certain receivers.

Upon receipt of an affirmative feedback reply message from the receiver, that is correlated with the original e-mail message (the comparison could be made using the original sent message identification number, for example), the sending station changes the status of the sent message to indicate “printing confirmed”. A graphical icon indicating that the sent message was printed could be displayed on the sent message line in the sent e-mail list. Further, a confirmation e-mail message could be added to the sender's “in-box”.

Alternatively, if no “Printed OK” affirmative feedback reply is received from the receiver within a (configurable) period of time, the sending station changes the status of the sent message to indicate “Warning: P-O-R not confirmed”, or the like. A graphical icon indicating that the P-O-R request failed to print the sent message could be displayed on the sent message line in the sent e-mail list. Further, a notification message could be added to the sender's “in-box”.

The sending station may automatically calculate the number of pages to be printed and may send this data in a selected field of the e-mail message (e.g. in the header). Or the sending station may automatically calculate the size of all the pages to be printed in bytes and send this data in a selected field of the e-mail message (e.g. in the header) to expedite the processing at the receiver station.

### BRIEF DESCRIPTION OF THE SEVERAL VIEWS OF THE DRAWING

FIG. 1 is a simplified block diagram of one embodiment of the invention, implemented over a wide area network connecting the e-mail sender and the e-mail receiver, showing the processes and systems for the outgoing message.

FIG. 1A is a simplified block diagram showing the major components of a wide area network by which an e-mail message is transmitted between the sender and the receiver.

FIG. 2 shows one method of presenting the configuration parameters used by the receiver to set up the e-mail program to process and automatically print incoming e-mail messages and attachments.

FIG. 3 is a logic flow diagram showing the processing of the incoming e-mail message based on the account to which the message is addressed

FIG. 4 is a logic flow diagram showing the processing of the incoming e-mail message based on the sender from which the message is received

FIG. 5 is a logic flow diagram showing the continuation of the processing of the incoming e-mail message (and optionally, attachments).

FIG. 6 is a logic flow diagram showing the continuation of the processing of the incoming e-mail message and the handling of printer errors.

FIG. 7 shows one method of presenting the configuration parameters used by the sender to set up the sending e-mail program.

FIG. 8 is a logic flow diagram showing the processing of outgoing P-O-R e-mail.

FIG. 8A is a logic flow diagram showing the processing of feedback (reply) e-mail messages.

### DETAILED DESCRIPTION OF THE INVENTION

1. Preamble

The present invention is a computer implemented process that is carried out by the computer in response to input from the sender (or sender application) and instructions provided by the program incorporating the present invention.

Although the preferred embodiments will be generally described in the context of a program running on a personal computer, those skilled in the art will recognize that the present invention also can be implemented in conjunction with other program modules for other types of computers.

The detailed description which follows is represented largely in terms of processes and symbolic representations of operations by conventional computer components. The processes and operations performed by the computer include the manipulation of signals by a CPU or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art. For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, bytes, words, data, objects, properties, flags, types, identifiers, values, elements, symbols, characters, terms, numbers, points, records, images, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, receiving, sending, transmitting, replying, etc. which are often associated with manual operations performed by a human operator. The operations described herein are machine operations performed in conjunction with various input provided by a human operator or user that interacts with the computer.

In addition, it should be understood that the programs, processes, methods, etc. described herein are not related or limited to any particular computer or apparatus, nor are they related or limited to any particular communication network architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hardwired logic or programs stored in nonvolatile memory, such as read only memory.

Note: while the invention has been described herein in detail with reference to the specific embodiment thereof, it would be apparent to those skilled in the art that various changes and modifications may be made therein without departing from the spirit of the invention.

The present invention expands on the existing methods for sending and receiving e-mail by incorporating a sender-initiated “print-on-receipt” (P-O-R) capability. A further enhancement provides a method for composing and sending a feedback message (or reply) to the sender to confirm that the P-O-R message has been successfully printed.

The optimum advantageous use of the present invention depends on widespread usage and acceptance of the functionality of P-O-R systems, including the adoption of common digital coding protocols and standards, and to the extent required, the installation of supporting software by as many e-mail software vendors as possible. Thus for convenience the invention is described herein as a set of improvements to the common, COTS e-mail programs such as Microsoft Outlook, Outlook Express, Eudora, Lotus, AOL or Netscape and the established or de facto standards applicable to such programs. However, those skilled in the art will recognize that the present invention conceivably could be implemented in a new e-mail program or e-mail server or it could be implemented as an improvement to an existing MAPI spooler system, or it could be implemented as a “MAPI Agent” or “plug-in” compatible with a COTS e-mail program, that easily could be installed by users to provide P-O-R capability in their existing, prior art e-mail system(s).

P-O-R functionality conceivably could also be added to any electronic messaging system, or to any e-mail server or to such messaging software that includes an e-mail receiver such as Microsoft Exchange Server to provide e-mail P-O-R capability within the e-mail server or network, whereby the e-mail server would process incoming messages and if so configured, would print the messages on a designated printer in the local area network or Intranet before the message is downloaded to the receiver's e-mail “in-box”.

The present invention is not concerned with specific choices of e-mail coding nor specific software implementations of the invention disclosed. Appropriate software and message coding can readily be designed and selected by skilled programmers and systems designers based on the teachings of the present disclosure and upon their general understanding of computers, e-mail systems, and e-mail message structure and coding. Future e-mail messaging standards that supercede SMTP or MAPI may conceivably incorporate P-O-R functionality and parameters.

One embodiment of the invention provides for printing e-mail messages composed in normal text, HTML or any other “de-facto” form. Another embodiment of the invention provides for printing e-mail attachment files in one or more of the common formats such as Rich Text Format (.rtf), Microsoft Word (.doc), Adobe Acrobat (.pdf) and the common graphical file formats such as TIFF, JPG, BMP, Adobe Photoshop etc.

Further embodiments of the invention provide a means for the e-mail receiver to utilize configurable parameters to chose to print all incoming P-O-R e-mail, or to print selected classes of incoming P-O-R e-mail, or to print or not print all or selected classes of incoming e-mail containing a P-O-R request.

Another embodiment of the invention provides a means for the receiver to specify a printer, other than the default printer, on which the P-O-R e-mail and optional attachment is to be printed.

Another embodiment of the invention provides a means for the receiver to limit the number of pages to be printed.

Another embodiment of the invention provides a means for the receiver to limit the total number of bytes to be printed.

2. The Operating Environment

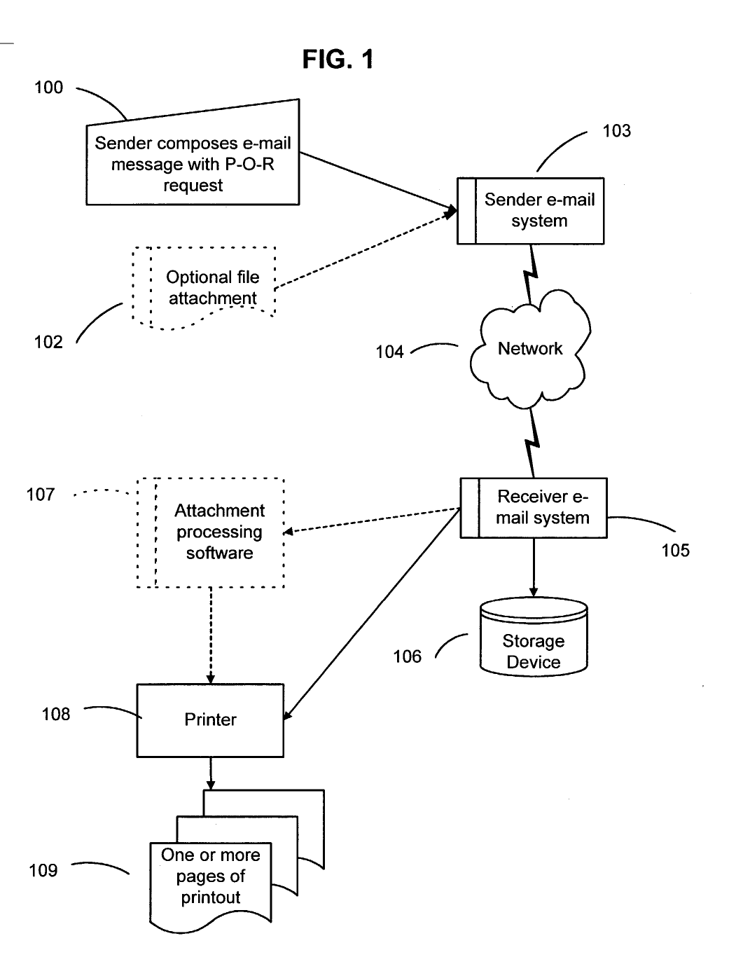

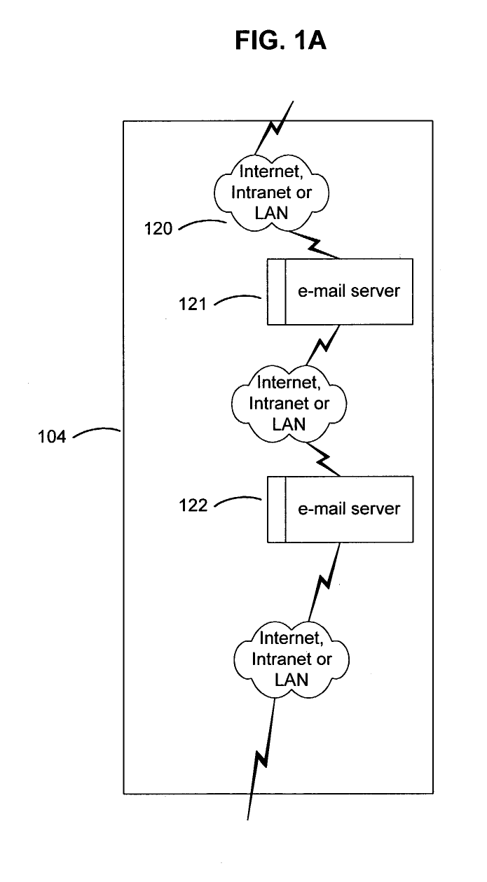

FIG. 1 is a simplified block diagram illustrating a conventional electronic messaging system suitable for supporting the operation of the preferred embodiment of the present invention, showing the processes and systems for the outgoing message. The system consists of a sender that utilizes an e-mail system 100 to compose and send a P-O-R e-mail message via a wide area network 104 (e.g. the Internet) using a sending e-mail system 103. Optionally the sender may attach a file 102 to the e-mail message to be printed.

FIG. 1A is a simplified block diagram illustrating the major components of a wide area network 104 that can store and forward e-mail messages. The sender's e-mail system 103 typically sends the outgoing e-mail message to the e-mail server 121 of the service to which they subscribe via their Internet connection 120. Said server 121 is capable of receiving, storing and forwarding the sent e-mail to the e-mail server of the intended recipient 122. The identity of said e-mail server is typically derived from the e-mail address of the recipient. The e-mail server of the intended recipient 122 stores the incoming e-mail message until the recipient's e-mail system 105 requests that it be transmitted, and instructs the e-mail server to delete the message from its storage. The workings of such servers is well understood in the prior art.

In other embodiments, the network 104 could be an Intranet or internal (local area) network that may be used to send and receive the e-mail within an organization.

In other embodiments, the sender system 103 could be a computer system operating without human intervention, for example an accounting system, an e-mail fax processing system, or a pathology laboratory results processing system.

The receiving part of the system is comprised of a receiver e-mail system 105 that downloads e-mail messages, and optional attachment files 102 from the Internet, Intranet or LAN 104 and stores them on the local storage device of the receiving computer 106.

The receiving e-mail system 105 may print the output to a designated printer 108 capable of printing on a sheet of paper 109 and being connected to a computer system for communicating by signals with the computer system.

Optionally, the e-mail system may need to invoke an application program 107 to handle the output and printing of an attachment file (using system commands for example). The appropriate application may be identified by the suffix of the file name, that identifies the file type, for example .doc (Microsoft Word), .jpg (compressed graphics file), .pdf (Acrobat Reader), etc. or may be an application capable of processing a multitude of different file formats, depending on the manner in which the receiver's computer operating system is configured.

3. Receiving System and Method

The receiving system includes a system and method for enabling an electronic mail (e-mail) system to process an incoming message, comprising an industry standard e-mail program, enhanced according to this invention to include the appropriate logic to print the message (and optionally any attached files) upon receipt without user intervention. The processing may include checking the value or state of one or more configurable parameters in the receiver's e-mail system and acting in accordance with the receiver's directives embodied in said parameters.

3.1 Receiving System Setup

Optionally, the receiving e-mail program may incorporate enhancements to the data files used to store the configuration parameters of the e-mail system, as well as the data files used to store the contacts (e.g. the address book). Some examples of the possible configuration parameters (or setup commands) are described herein to illustrate the preferred embodiment of the invention.

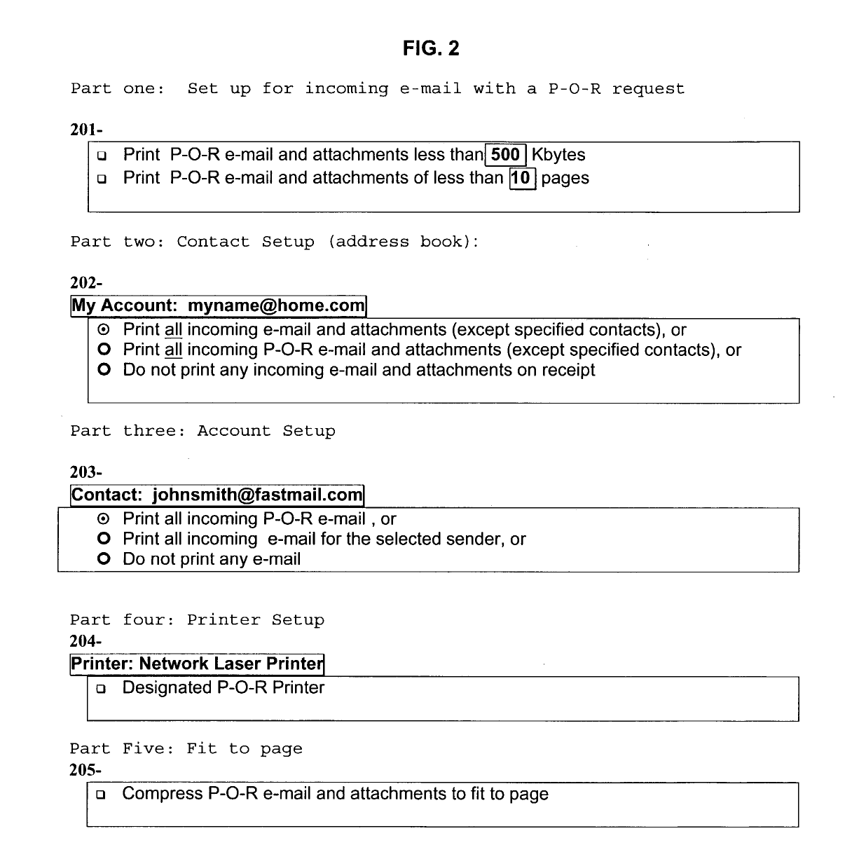

FIG. 2 illustrates one method of presenting the configuration parameters used by the receiver to set up the e-mail program to process and automatically print incoming e-mail messages and attachments. The e-mail system configuration file includes a parameter, and provides a user interface 201 to set and un-set said parameter that instructs the receiving system to print on receipt only incoming P-O-R e-mail of a total size less than a specified number of bytes or a specified number of printed pages.

In another embodiment of the invention the e-mail system configuration file 202 includes a variable choice of parameters for one or more of the receiver's e-mail accounts, and provides a user interface to set and un-set said parameters for each account that instruct the receiving system to (a) to print all incoming e-mail and attachments upon receipt without operator intervention for all contacts unless specifically excluded, or (b) to print all incoming P-O-R e-mail and attachments upon receipt without operator intervention for all contacts unless specifically excluded, or (c) not to print any incoming e-mail or attachments without operator intervention for the selected account.

In another embodiment of the invention the e-mail system configuration file includes a variable choice of parameters, and provides a user interface 203 to set and un-set said parameters that instructs the receiving system, for a selected e-mail contact (sender), (a) to print all incoming e-mail for the selected sender, (b) to print all incoming e-mail containing a P-O-R request (and optionally, attachments), or (c) to reject any P-O-R requests for the specified sender.

In another embodiment of the invention the e-mail system configuration file includes a parameter, and provides a user interface in the printer setup 204 to set and un-set said parameter that instructs the receiving system to print on receipt e-mail (and optionally, attachments) only on a designated printer.

In another embodiment of the invention the e-mail system configuration file includes a parameter, and provides a user interface 205 to set and un-set said parameter that gives the receiver the choice to have all P-O-R designated incoming e-mail (and optionally, attachments) text (and optionally graphics) compressed if necessary (“reduced to fit”) to fit the default paper size loaded in the printer designated to print P-O-R designated incoming e-mail.

3.2 Receiving System Processing Logic

The functionality described herein is not envisaged to require extraordinary programming skills and would be well within the competence of a programmer versed in the current art and familiar with the workings of the current state of the art e-mail programs or MAPI plug-ins. The embodiment described herein describes only one possible manner in which the invention could be implemented. The invention could be implemented with only the simplest P-O-R functionality, or with some or all of the features described herein. There exist many combinations and permutations of the optional features, and they may be implemented by different programmers in a variety of ways depending on the programmer's preferences for language, operating system, e-mail system, e-mail server, or other software engineering constraints.

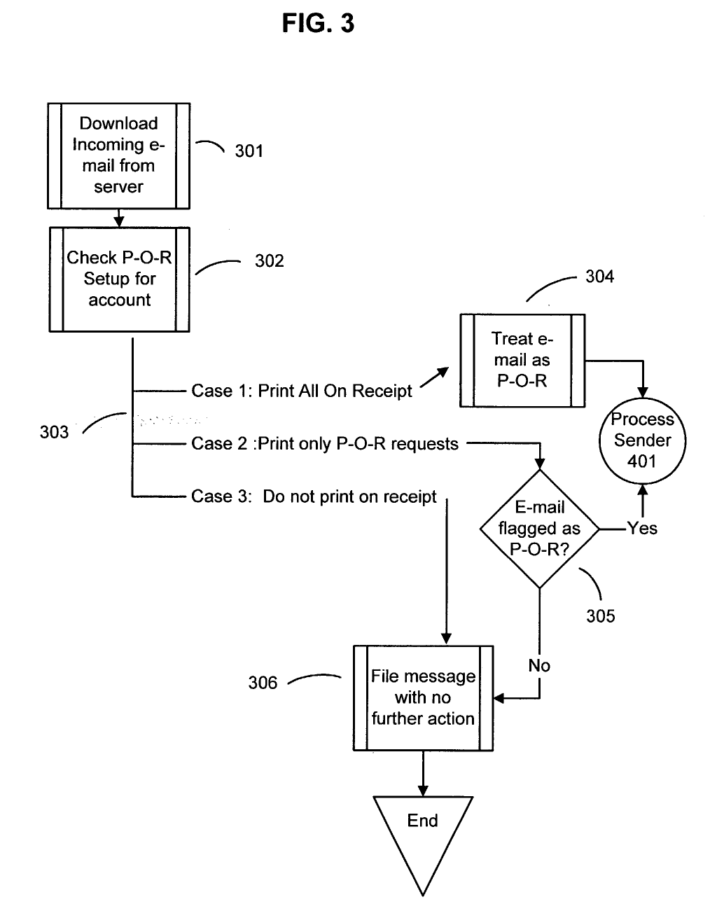

FIG. 3 illustrates one method of processing of the incoming e-mail message based on the account to which the message is addressed. In one embodiment of the present invention, upon downloading an e-mail message 301 the receiving e-mail program checks the value or state of a setup parameter 302 to determine if the receiver wishes to print all incoming e-mail for the account (i.e. e-mail address) to which the e-mail message is addressed, and if so, the program further processes the message (and optional attachments) as if it contained a P-O-R request 304 and proceeds to the logic for processing P-O-R messages 401.

In the event that the setup parameter 303 is set to “Print only incoming e-mail and attachments with a P-O-R request, the e-mail program further checks to verify that the incoming e-mail message contains a P-O-R request 305 and if so, proceeds to the logic for processing P-O-R messages 401. If this setup parameter is not set, the program proceeds to the logic for storing incoming messages 306.

In the event that the e-mail user has checked (set) the setup parameter 303 indicating that no incoming messages received on the selected account are to be automatically printed, the program proceeds to the logic for storing incoming messages 306.

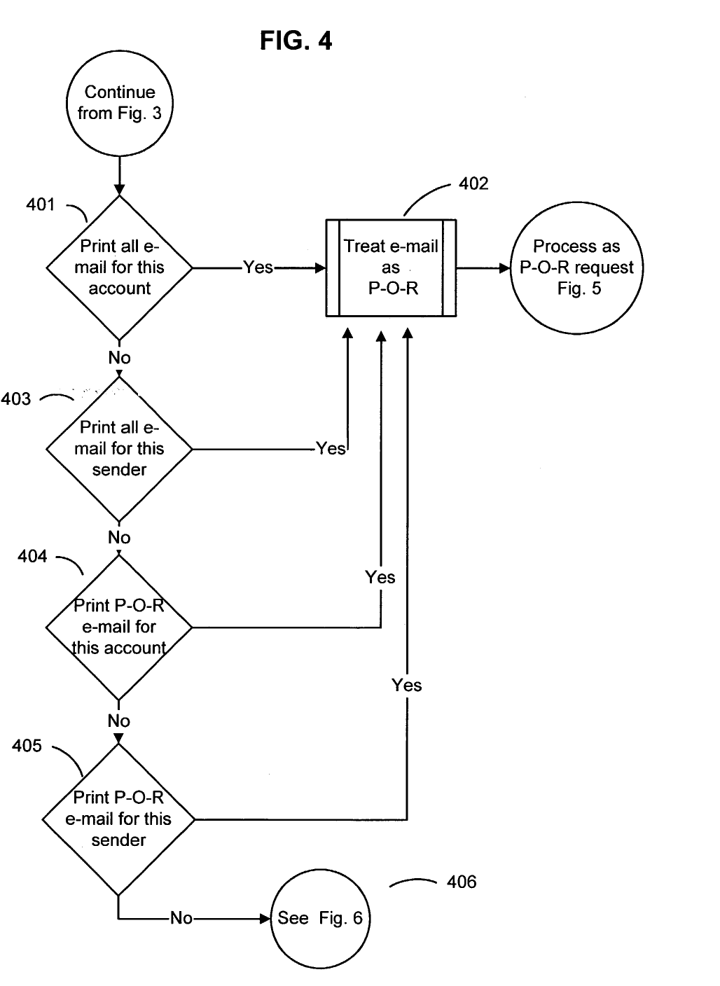

FIG. 4 illustrates one method of processing of the incoming e-mail message based on the sender from which the message is received. In another embodiment of the present invention, the receiving e-mail program further checks the value or state of a setup parameter 401 to determine if the receiver wishes to print all incoming e-mail for the sender (i.e. the sender's e-mail address in the incoming message), and if so, the program further processes the message (and optional attachments) as a P-O-R request by the sender 402 and sends them to the appropriate printer as described below.

In the event that the setup parameter 403 is set to “Print only incoming e-mail and attachments with a P-O-R request, the e-mail program further checks to verify that the incoming e-mail message contains a P-O-R request 405 and if so, proceeds to the logic for processing P-O-R messages (as described below). If this setup parameter is not set, the program proceeds to the logic for processing replies to P-O-R requests 406.

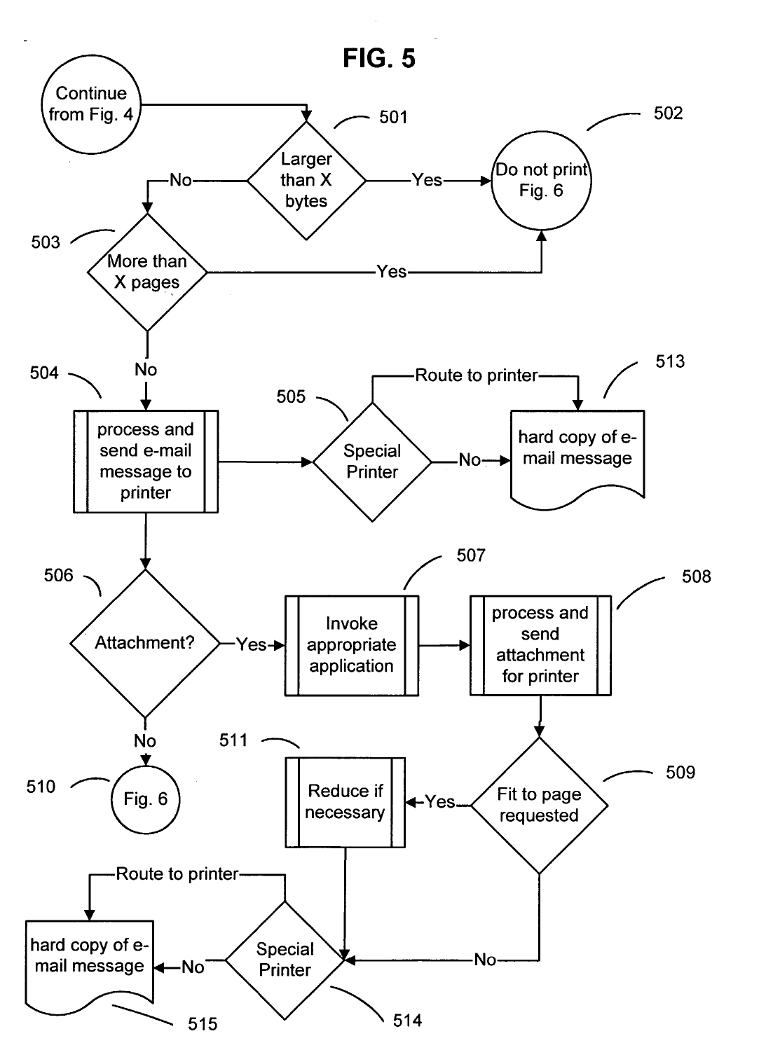

FIG. 5 illustrates one method for the continuation of the processing of the incoming e-mail message (and optionally, attachments). In another embodiment, before printing e-mail or attachments, the e-mail program further checks the e-mail configuration 501 to determine if the user has set a configurable parameter to indicate that the user wishes to print only e-mail messages and optional attachments of a combined size less than a specified number of bytes. In this event, the program may calculate the size in bytes and compare the result against the set value 501, and if it is less than or equal the set value in bytes, the e-mail program processes the e-mail and attachments and send them to the appropriate printer as described below 502.

In another embodiment, before printing e-mail or attachments, the e-mail program further checks the e-mail configuration 503 to determine if the user has set a configurable parameter to indicate that the user wishes to print only e-mail messages and optional attachments of a combined size less than a specified number of printed pages. In this event, the program may calculate the size in printed pages and compare the result against the set value, and if it is less than or equal the set value, the e-mail program processes the e-mail and attachments and sends them to the appropriate printer 502 as described below.

In another further improvement, the receiving e-mail program may check for a data field in the e-mail message header to determine the total size of the P-O-R message in bytes 501 and compares this number with the user configurable parameter. If the user has specified a smaller number of acceptable bytes the program processes the message as a rejected P-O-R request 606.

In another further improvement, the receiving e-mail program may check for a data field in the e-mail message header to determine the total size of the P-O-R message in pages 503 and compares this number with the user configurable parameter. If the user has specified a smaller number of acceptable pages, the program processes the message as a rejected P-O-R request 606.

In the event that the processing approves the e-mail P-O-R request, or the message is to be treated as if it were a P-O-R request, the program processes the e-mail message (whether text, HTML or any other embedded format) 504 and sends it to the default printer which produces a hard copy on paper 513. In a further improvement, prior to sending the e-mail message to the printer, the program checks a configuration parameter 505 in the printer setup to determine whether P-O-R messages are to be printed on a specially designated printer, and if so it diverts the printed output to the said printer.

In the event that the e-mail message contains an attached file 506, a further embodiment may be programmed to print attachments in the common text file types such as Microsoft Word documents, Rich Text Format (.rtf), Adobe (.pdf), as well as the common graphic image file formats such as JPG, TIFF, BMP by invoking the appropriate application 507 to process the attachment file for printing and sending it to the printer queue 508. The respective application programs that are invoked to open the attachment (e.g. MS Word, Adobe Acrobat, Microsoft Imager or an all-purpose file printing application such as Jasc Software's Quick View Plus etc.), are triggered to print the attachments 508 without operator intervention. In one embodiment, these applications may incorporate a print-on-open capability, or in another embodiment, they may be triggered to print the document or image opened using a system level command, or by using keystroke emulation (or mouse click emulation) to trigger the print command.

In a further improvement, prior to sending the attachment to the printer, the receiving e-mail program checks the user configurable parameters 509 to determine if the user has specified that an incoming P-O-R message is to be reduced in size if necessary to fit the paper loaded in the default or designated printer, and if so, it sends the appropriate codes to the printer to make the output “Fit to page” 511.

In a further improvement, prior to sending the attachment to the printer, the program checks a configuration parameter 514 in the printer setup to determine whether P-O-R messages are to be printed on specially designated printer, and if so it diverts the printed output 515 to the said printer.

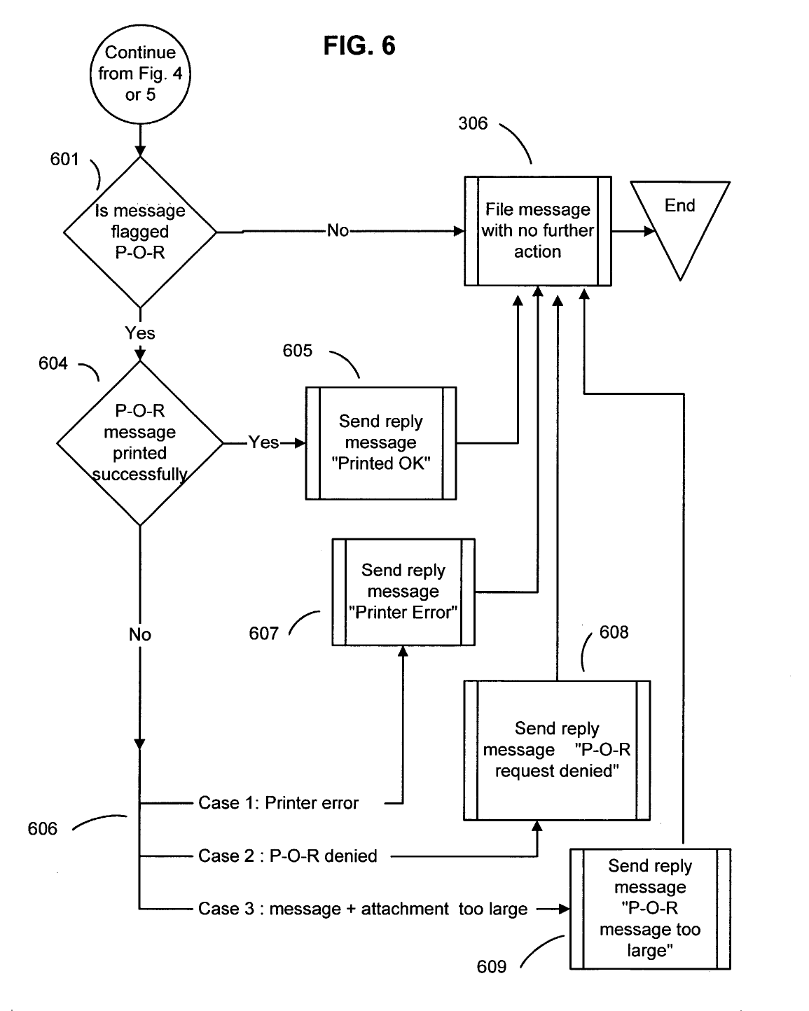

FIG. 6 illustrates one method for the continuation of the processing of the incoming e-mail message and the handling of printer errors. After the receiving e-mail program has printed or attempted to print the e-mail message (and optionally, an attachment), in the preferred embodiment, the receiving e-mail program further checks the status of the incoming e-mail message 601 to determine if contains a P-O-R request, and if not, the message is processed and filed 602 in the conventional manner with no further action 603.

In the event that the printed e-mail message does contain a P-O-R request, and there are no errors 604, in the preferred embodiment of the invention, the program composes and sends a reply message 605 containing a text message and/or a code to inform the sender and/or the sender's e-mail system that the message (and optional attachments) were printed successfully on the receiving station. In a further improvement, the status of the incoming e-mail message is changed to indicate graphically to the receiver that the message (and optional attachments) was printed. After this step the incoming message is processed and filed 602 in the conventional manner with no further action 603.

In the preferred embodiment of the invention, in the event 606 that the incoming e-mail message contains a P-O-R request, and for some reason there was a printer error, when the P-O-R e-mail program is notified of the error by the printer driver, said e-mail program composes and sends a reply message 607 containing a text message and/or a code to inform the sender and/or the sender's e-mail system that the message (and optional attachments) failed to be printed successfully on the receiving station. In a further improvement, the specific nature of the error (e.g. “Printer out of paper”) would be included in the text message and/or a code. In a further improvement, the status of the incoming e-mail message is changed to indicate graphically to the receiver that the P-O-R message (and optional attachments) failed to be printed. After this step the incoming message is processed and filed 602 in the conventional manner with no further action 603.

In the event 606 that the incoming e-mail message contains a P-O-R request, and the receiver has configured the e-mail program to deny P-O-R requests, the receiving e-mail program composes and sends a reply message 608 containing a text message and/or a code to inform the sender and/or the sender's e-mail system that the incoming message (and optional attachments) failed to be printed successfully on the receiving station. In a further improvement, the specific nature of the error (e.g. “Receiver does not allow P-O-R requests”) would be included in the text message and/or a code. In a further improvement, the status of the incoming e-mail message is changed to indicate graphically to the receiver that the P-O-R message (and optional attachments) failed to be printed. After this step the incoming message is processed and filed 602 in the conventional manner with no further action 603.

In the event 606 that the incoming e-mail message contains a P-O-R request, and the receiver had configured the e-mail program to deny P-O-R requests for messages and optionally attachments greater than the specified size (in bytes or pages), the receiving e-mail program composes and sends a reply message 609 containing a text message and/or a code to inform the sender and/or the sender's e-mail system that the message (and optional attachments) failed to be printed successfully on the receiving station. In a further improvement, the specific nature of the error (e.g. “Message and attachments too large”) would be included in the text message and/or a code. In a further improvement, the status of the incoming e-mail message is changed to indicate graphically to the receiver that the P-O-R message (and optional attachments) failed to be printed. After this step the incoming message is processed and filed 602 in the conventional manner with no further action 603.

In another embodiment, more specific error handling is included such that the specific nature of the error (e.g. “Unknown file type—attachment could not be printed”) would be included in the text message and/or a code.

4. Sending System and Method

In the preferred embodiment of the invention, the sending system includes a system and method for enabling an electronic mail (e-mail) system to send an outgoing message, comprising an industry standard e-mail program, enhanced to include the appropriate logic and functionality to allow the sender to include a P-O-R request in the outgoing message. In a further improvement, the sending system (or sending program) includes configurable parameters and processing logic to control the outgoing P-O-R e-mail and to respond to a reply from the receiver of a P-O-R e-mail previously sent.

In another embodiment, the sending system could be a computer application such as accounting systems, e-mail fax delivery systems, and pathology laboratory results distribution systems, that automatically generate and send P-O-R e-mail.

4.1 Sending System Setup

The sending e-mail program incorporates enhancements to the data files used to store the configuration parameters of the e-mail system, as well as the data files used to store the contacts (e.g. the address book). Some examples of the possible configuration parameters (or setup commands) are described herein to illustrate the preferred embodiment of the invention.

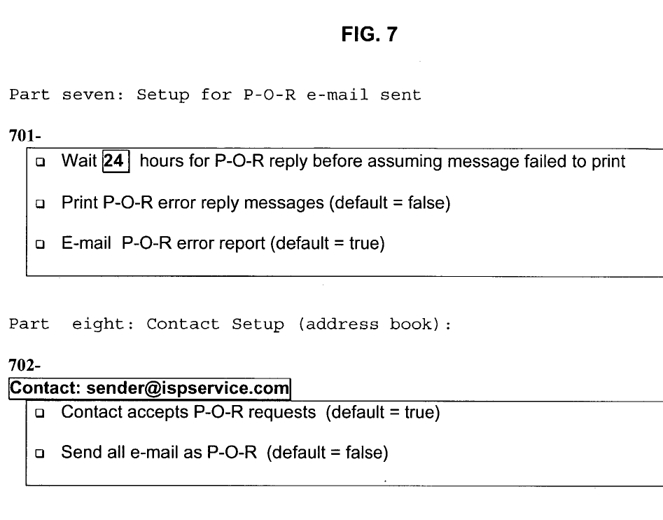

FIG. 7 illustrates one method of presenting the configuration parameters used by the sender to set up the e-mail program process the feedback (reply) e-mail messages. In one embodiment of the invention the e-mail system configuration file includes a parameter, and provides a user interface 701 to set and un-set said parameter that instructs the sending e-mail program as to the length of time to wait before generating an error message at the sending station for a P-O-R message that has not been acknowledged by the receiver.

In another embodiment, the e-mail system configuration file includes a parameter, and provides a user interface 701 to set and un-set said parameter that instructs the sending e-mail program to automatically print an error report (or compose and store an e-mail message containing an error report) at the sending station for a P-O-R message (or set of P-O-R messages) that has not been acknowledged by the receiver after the specified waiting period, or any P-O-R reply message indicating an error whereby the sent P-O-R message was not printed at the receiving station.

In another embodiment of the invention the e-mail system configuration file includes a parameter, and provides a user interface in the printer setup 702 in the contact list (or address book) setup, to set and un-set said parameter that informs the sending system that a selected contact (or address book entry) accepts P-O-R requests and optionally, to always send e-mail to this contact as P-O-R e-mail.

4.1 Sending System Processing Logic

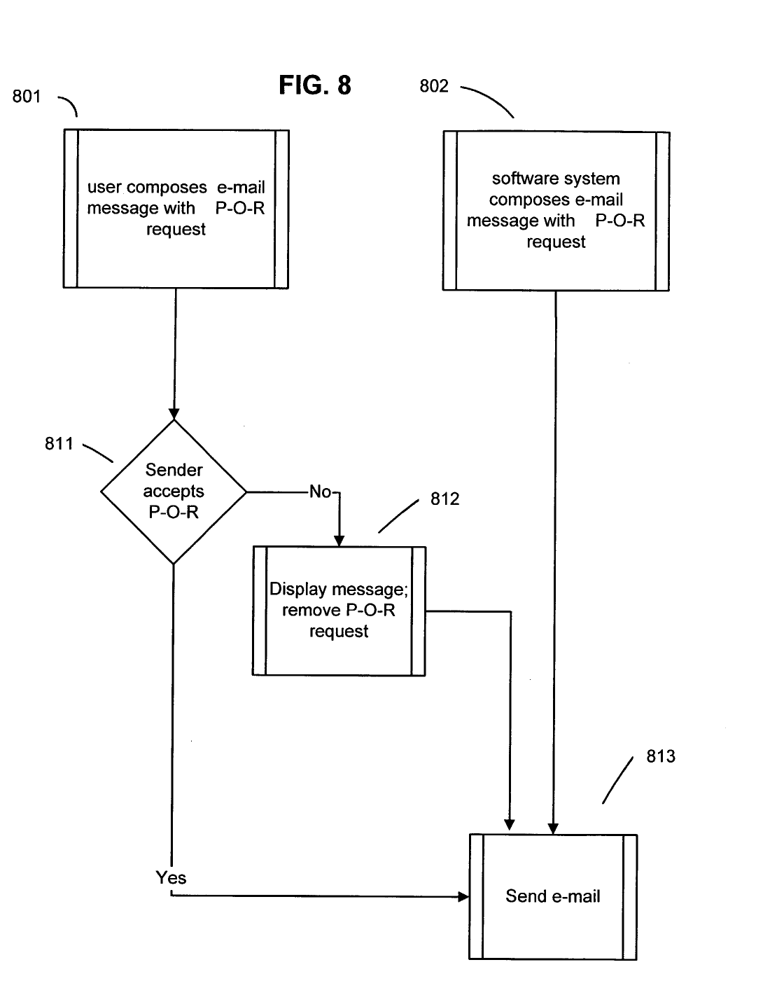

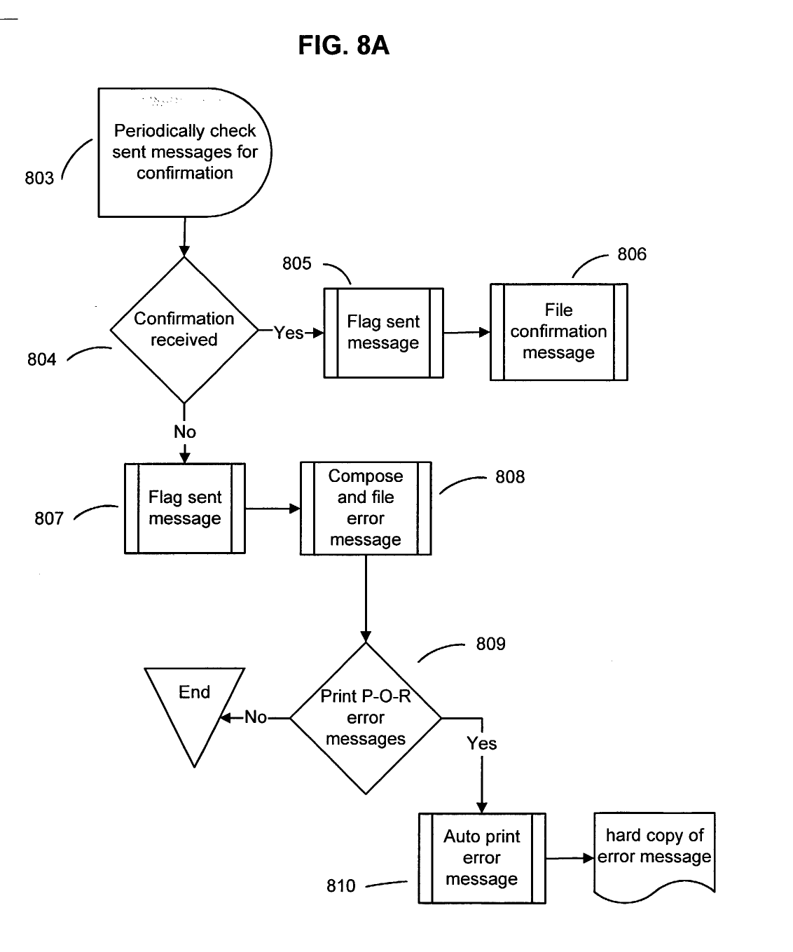

FIG. 8 is a logic flow diagram showing the processing of outgoing P-O-R e-mail. In the preferred embodiment of the present invention, the sending e-mail program incorporates logic and e-mail processing code includes a user interface 801 whereby the sender may set and un-set a flag or field or other suitable property in the outgoing message, that represents a P-O-R request. If the contact is set to “always send as P-O-R” 702, then the e-mail program would set the P-O-R flag automatically when the e-mail message is “sent”.

In the preferred embodiment of the invention, said P-O-R flag would be in one of the data fields of the message header. In any event, the location of said P-O-R flag or code or property would be agreed upon by all e-mail software vendors such that it is “standardized”.

Said P-O-R request code is placed by the system in the “standard” (e.g. SMTP) designated P-O-R request field in the outgoing e-mail message before sending the e-mail message 813.

Conceivably, the “standard” e-mail header data structure could be modified to include a new P-O-R code, but such non-standard e-mail header might cause “backward compatibility” problems with existing e-mail programs. The optimum advantageous use of this invention depends on utilizing the conventional “standard” data structure (e.g. SMTP) of e-mail messages, and/or the use of compatible program modules (e.g. MAPI plug-ins), so that as many e-mail systems as possible can be easily modified to process P-O-R e-mail, and so that older e-mail systems can still process incoming P-O-R e-mail in the conventional manner. For example, to implement a P-O-R request, an existing code field in the conventional e-mail message header such as the Importance field could be used to request that e-mail program at the receiver station process the message as a P-O-R request.

In one embodiment, the sending e-mail program checks 811 the e-mail configuration to determine if the user has set the configurable parameter in the receiver's contact record (or address book entry) record, to determine if the receiver is known to accept and print P-O-R messages upon receipt. If the flag is set to “No” or “False” the e-mail program may optionally display a warning message 812 to the sender and may in a further embodiment, remove the P-O-R request from the outgoing message before sending the e-mail message 813.

In another embodiment, the outgoing P-O-R e-mail may be composed by a software system or application 802 (e.g. an accounting system).

In another further improvement, the sender e-mail program automatically calculates the number of printed pages and also sends this data in a data field of the e-mail message (e.g. in the header).

In another further improvement, the sender e-mail program automatically calculates the size in bytes of the printed pages and also sends this data in a data field of the e-mail message (e.g. in the header).

In a preferred embodiment of this invention, after printing has been completed or at least initiated, the receiving station sends to the sending station a feedback message (reply) to indicate that the received message has been printed on the receiver's printer with no printer errors detected 605, or else sends to the sending station an error message or a P-O-R rejection message or the like 607.

FIG. 8A illustrates one method the processing of feedback (reply) e-mail messages. In another embodiment, the receiving station includes logic 803 to periodically check a setup parameter and calculate the time elapsed since each P-O-R message of status “unconfirmed” was sent. If the time lapsed is greater than the user configured time, the P-O-R message status is changed to “expired” or the like.

In the event that a confirmation reply or affirmative feedback e-mail message is received 804, it is flagged as “printed OK” or the like, and the e-mail system updates the status of the corresponding sent e-mail message to “printed OK”. One embodiment of this enhancement uses the message number to identify and match the incoming confirmation message with the original “print-on-receipt” message sent. Another embodiment uses a graphic symbol or icon beside the message in the list of message (e.g. the “Sent” folder) to indicate “printed OK” 805. In another embodiment, the confirmation e-mail message may be filed in the senders “in box” or “new mail” folder 806.

In another embodiment of the sending e-mail system, in the event that a negative feedback e-mail message (reply) is received the system updates the status of the corresponding sent e-mail message to “Print Error” or the like. Another embodiment inserts a graphic symbol or icon beside the message in the list of message (e.g. the “Sent” folder) to indicate “printer error” 807.

In another embodiment, the sending e-mail system stores the error message (or set of error messages) as a regular e-mail message 808. Another embodiment checks the appropriate setup parameter, 809 and if so directed prints the error message 810 upon receipt.

5. Summary of the Detailed Description

From the foregoing description, it will be appreciated that the present invention provides an improved system and method for providing sender-initiated printing of electronic messages (and in particular e-mail messages and optional attachments) on receipt, without user intervention at the receiving station, providing a form of “guaranteed delivery” by means of a positive feedback massage.

No particular programming language has been described for carrying out the various procedures described above because it is considered that the operations, steps, and procedures described above and illustrated in the accompanying drawings are sufficiently disclosed to permit one of ordinary skill in the art to practice the present invention. Moreover, there are many computers and operating systems which may be used in practicing the present invention and therefore no detailed computer program could be provided which would be applicable to all of these many different systems. Each user of a particular computer will be aware of the language and tools which are most useful for that user's needs and purposes.

The present invention has been described in relation to particular embodiments which are intended in all respects to be illustrative rather than restrictive. Alternative embodiments will become apparent to those skilled in the art to which the present invention pertains without departing from its spirit and scope. Accordingly, the scope of the present invention is defined by the appended claims rather than the foregoing description.

1. A method and system for enabling a electronic messaging system, and in particular an electronic mail (referred to herein as “e-mail”) system or program to process an incoming or downloaded message (or a plurality of messages), transmitted over a network, from an operator or program (referred to herein as the “sender”) on one computer to a second operator (referred to herein as the “receiver”) on a second computer, the method comprising:
a suitable operating environment including computers capable of connecting to a network such as the Internet, an Intranet, a local area network, a wide area network, a satellite network, a cable network, a telephony network, a wireless network, or other data network which enables the communication of e-mail;
a suitable printer connected to the receiver's computer;
an e-mail system installed on the receiver's computer capable of downloading messages by connecting to an e-mail server or network;
said e-mail receiving system further enhanced to process and print incoming e-mail messages (and optionally any attached files) upon receipt without user intervention in response to a sender's print-on-receipt (P-O-R) request;
an e-mail system installed on the sender's computer capable of transmitting (“sending”) messages by connecting to an e-mail server or network, and said e-mail sending system further enhanced to allow the sender to incorporate a code or flag or other property in the outgoing e-mail message to signify a request to the receiver's e-mail system to print the e-mail messages (and optionally any attached files) sent, upon receipt, without user intervention.

2. The method of claim 1, further comprising a method for storing a set of configurable parameters, and providing a user interface to set and un-set said parameters, for each of the receiver's e-mail accounts, that instruct the receiving program:
to print all incoming e-mail upon receipt without operator intervention for all contacts, or
to print all incoming P-O-R e-mail upon receipt without operator intervention for all contacts, or
not to print any incoming e-mail or attachments without operator intervention for the selected account.

3. The method of claim 2, further comprising a method for storing a set of configurable parameters, and providing a user interface to set and un-set said parameters, for each of the receiver's e-mail accounts, that instruct the receiving program:
to print all incoming e-mail upon receipt without operator intervention for all contacts unless the sender is specifically excluded, or
to print all incoming P-O-R e-mail upon receipt without operator intervention for all contacts unless the sender is specifically excluded.

4. The method of claim 1, further comprising a method for storing a set of configurable parameters, and providing a user interface to set and un-set said parameters, for each e-mail sender (i.e. “contact” or address book entry in the receiver's e-mail address book), that instruct the receiving program:
to print all incoming e-mail upon receipt without operator intervention for the selected contact, or
to print all incoming e-mail upon receipt without operator intervention for the selected contact only if the e-mail message contains a P-O-R request, or
not to print any incoming e-mail without operator intervention for the selected contact.

5. The method of claim 1, further comprising a method for storing a configurable parameter, and providing a user interface to set and un-set said parameter that instructs the receiving program to print on receipt only incoming e-mail containing a P-O-R request of a total size less than a specified number of bytes.

6. The method of claim 1, further comprising a method for storing a configurable parameter, and providing a user interface to set and un-set said parameter that instructs the receiving program to print on receipt only incoming e-mail containing a P-O-R request of a total size less than a specified number of printed pages.

7. The method of claim 1, further comprising a method for storing a configurable parameter, and providing a user interface to set and un-set said parameter that instructs the receiving program to print on receipt e-mail only on a designated printer.

8. The method of claim 1, further comprising a method for storing a configurable parameter, and providing a user interface to set and un-set said parameter that gives the receiver the choice to have all P-O-R designated incoming e-mail message text (and optionally graphics) formatted if necessary (“reduced to fit”) to fit the default paper size loaded in the printer designated to print P-O-R designated incoming e-mail.

9. The method of claim 1, further comprising a method whereby the receiving e-mail program includes variable response logic whereby an the e-mail program, upon receiving new e-mail from the e-mail server, checks the value or state of one or more e-mail configuration file P-O-R parameters (hereinafter for convenience referred to as “setup parameters”) and responds with the appropriate action.

10. The method of claim 9, further comprising a method whereby the receiving e-mail program checks the value or state of a setup parameter to determine if the receiver wishes not to print any incoming e-mail for the account (i.e. e-mail address) to which the e-mail message is addressed, and if so, the program further processes the message as if it did not contain a P-O-R request.

11. The method of claim 9, further comprising a method whereby the receiving e-mail program checks the value or state of a setup parameter to determine if the receiver wishes to print all incoming e-mail for the account (i.e. e-mail address) to which the e-mail message is addressed, and if so, the program further processes the message as if it contained a P-O-R request.

12. The method of claim 9, further comprising a method whereby the receiving e-mail program checks the value or state of a setup parameter to determine if the receiver wishes to print incoming e-mail for the account (i.e. e-mail address) to which the e-mail message is addressed only if the message contains a P-O-R request, and if so, the program further checks to determine if the message contains a P-O-R request, and if so, the program further processes the message as a P-O-R request.

13. The method of claim 9, further comprising a method whereby the receiving e-mail program checks the value or state of a setup parameter to determine if the receiver wishes not to print any incoming e-mail from the sender (i.e. contact or address book entry) from which the e-mail message originated, and if so, the program further processes the message as if it did not contain a P-O-R request.

14. The method of claim 9, further comprising a method whereby the receiving e-mail program checks the value or state of a setup parameter to determine if the receiver wishes to print all incoming e-mail from the sender (i.e. contact or address book entry) from which the e-mail message originated, and if so, the program further processes the message as if it were P-O-R e-mail (i.e. it contained a P-O-R request).

15. The method of claim 9, further comprising a method whereby the receiving e-mail program checks the value or state of a setup parameter to determine if the receiver wishes to print incoming P-O-R e-mail from the sender (i.e. contract or address book entry) from which the e-mail message originated only if the message contains a P-O-R request, and if so, the program further checks to determine if the message contains a P-O-R request, and if so, the program processes the message as a P-O-R request.

16. The method of claim 9, further comprising a method whereby the receiving e-mail program checks the value or state of a setup parameter to determine if the receiver wishes to print incoming P-O-R e-mail messages of a size greater than a specified number of bytes, and if so, the program may calculate the size in bytes and compare the result against the set value, and if it is less than or equal the set value in bytes, the e-mail program continues to processes the e-mail as a P-O-R request, and if not the program further processes the message as if it did not contain a P-O-R request.

17. The method of claim 9, further comprising a method whereby the receiving e-mail program checks the value or state of a setup parameter to determine if the receiver wishes to print incoming P-O-R e-mail messages of a size greater than a specified number of bytes, and if so, the program may locate the size in bytes in the message header information and compare the size against the set value, and if it is less than or equal the set value in bytes, the e-mail program continues to processes the e-mail as a P-O-R request, and if not the program further processes the message as if it did not contain a P-O-R request.

18. The method of claim 9, further comprising a method whereby the receiving e-mail program checks the value or state of a setup parameter to determine if the receiver wishes to print incoming P-O-R e-mail messages of a size greater than a specified number of printed pages, and if so, the program may calculate the size in pages and compare the result against the set value, and if it is less than or equal the set value, the e-mail program continues to processes the e-mail as a P-O-R request, and if not the program further processes the message as if it did not contain a P-O-R request.

19. The method of claim 9, further comprising a method whereby the receiving e-mail program checks the value or state of a setup parameter to determine if the receiver wishes to print incoming P-O-R e-mail messages a size greater than a specified number of printed pages, and if so, the program may locate the size in bytes in the message header information and compare the size against the set value, and if it is less than or equal the set value, the e-mail program continues to processes the e-mail as a P-O-R request, and if not the program further processes the message as if it did not contain a P-O-R request.

20. The method of claim 1, further comprising a method for initiating the printing routines to print an incoming P-O-R e-mail message without user intervention.

21. The method of claim 20, further comprising a method whereby the receiving e-mail program, after one or more checks of the configuration logic, and determining that the P-O-R e-mail message is to be automatically printed upon receipt without operator intervention, further processes the e-mail message by formatting the e-mail message (whether text, HTML or any other embedded format) for printing, and sending the formatted message to the receiver's default printer which produces a hard copy on paper.

22. The method of claim 21, further comprising a method whereby the receiving e-mail program, prior to sending the formatted message to the default printer, checks the value or state of a setup parameter to determine if the receiver wishes to print incoming P-O-R e-mail messages to a specially designated printer, and if so, sends the formatted message to the designated printer which produces a hard copy on paper.

23. The method of claim 21, further comprising a method whereby the receiving e-mail program, prior to sending the formatted message to the default printer, checks the value or state of a setup parameter to determine if the receiver wishes to ensure that the formatted output is reduced to the printable area of the default or designated printer, and if so, sends the appropriate codes to the printer to “reduce to fit the page” if necessary.

24. The method of claim 1, further comprising a method for processing files attached to incoming P-O-R e-mail designated to be printed without operator intervention.

25. The method of claim 24, further comprising a method of including the e-mail attachment as part of the e-mail message for all the applicable configuration parameter setup described in claims 2 through 8 inclusive.

26. The method of claim 24, further comprising a method of including the e-mail attachment as part of the e-mail message for all the applicable processing logic described in claims 9 through 15 inclusive.

27. The method of claim 24, further comprising a method of including the size of the e-mail attachment as part of the e-mail message for all the applicable processing logic described in claims 16 through 19 inclusive.

28. The method of claim 24, further comprising a method of determining that a P-O-R e-mail message just printed contains an attachment in a file format which the receiver's e-mail program is capable of formatting for printing, and if so, the e-mail program formats and prints the attachment and sends it to the default or the designated printer.

29. The method of claim 24, further comprising a method of determining that a P-O-R e-mail message just printed contains an attachment in a file format for which the receiver's computer is able to invoke another application capable of formatting and printing the attachment, and if so, invoking the appropriate application with a suitable set of commands to format and print the attachment and send it to the default or the designated printer.

30. The method of claim 24, further comprising a method whereby the receiving e-mail program, prior to sending the formatted attachment to the default printer, checks the value or state of a setup parameter to determine if the receiver wishes to ensure that the formatted output is reduced to the printable area of the default or designated printer, and if so, sends the appropriate codes to the printer (or to the application formatting the data to be printed) to “reduce to fit the page” if necessary.

31. The method of claim 1, further comprising a method whereby the receiving e-mail program composes and sends a reply message to the sender containing either a positive feedback message or a negative feedback message relating to a specific P-O-R e-mail message received from the sender.

32. The method of claim 31, further comprising a method whereby the receiving e-mail program, after printing a P-O-R e-mail message (and optionally, any attachments to said e-mail message), composes and sends an e-mail reply message containing a code and/or message to inform the sender that the e-mail message (and optionally its attachments) were successfully printed.

33. The method of claim 31, further comprising a method whereby the receiving e-mail program, after failing for any reason to print a P-O-R e-mail message (and optionally, any attachments to said e-mail message), composes and sends an e-mail reply message containing a code and/or message to inform the sender that the e-mail message (and optionally its attachments) were not printed.

34. The method of claim 32, further comprising a method whereby the receiving e-mail program, after failing for any reason to print a P-O-R e-mail message (and optionally, any attachments to said e-mail message), composes an e-mail reply message containing a more specific code and/or message to inform the sender that the e-mail message (and optionally its attachments) were not printed and further to inform the sender of the reason that the e-mail message (and optionally its attachments) were not printed.

35. The method of claim 1, further comprising a method for enabling an e-mail system to send an outgoing message, comprising an industry standard e-mail program, enhanced to include a user interface to allow the sender to include a P-O-R request in the outgoing message (“P-O-R e-mail”).

36. The method of claim 35 further comprising user configurable parameters and processing logic to control the outgoing P-O-R e-mail and to respond to a reply from the receiver of a P-O-R e-mail previously sent.

37. The method of claim 35, further comprising a method for storing a configurable parameter, and providing a user interface to set and un-set said parameter that instructs the sending program to wait a specified length of time after sending an e-mail message containing a P-O-R request, and to periodically check for a reply message for each P-O-R message pending acknowledgement. If no reply or acknowledgement message is received after such time for the corresponding e-mail sent, to indicate to the sender, by means of a graphical symbol or icon displayed in the sent e-mail list, that the P-O-R request (or a plurality of P-O-R requests) was never acknowledged.

38. The method of claim 37, further comprising a method for composing an e-mail error message to be inserted and displayed in the sender's in box (or new mail) e-mail list, to inform the sender that the P-O-R request was never acknowledged.

39. The method of claim 35, further comprising a method for processing incoming e-mail messages on the sender's system, and filtering and processing e-mail responses to previously sent P-O-R e-mail sent.

40. The method of claim 35, further comprising a method for identifying a P-O-R reply message containing a positive feedback code or message and to indicate a change of the status of the sent message to the sender, by means of a graphical symbol or icon displayed in the sent e-mail list, that the original P-O-R request was successfully printed at the receiver's station.

41. The method of claim 35, further comprising a method for identifying a P-O-R reply message containing a negative feedback code or message and to indicate to the sender, by means of a graphical symbol or icon displayed in the sent e-mail list, that the original P-O-R request was not printed at the receiver's station.

42. The method of claim 35, further comprising a method for disposing of a P-O-R reply message once the original corresponding entry in the sent e-mail list has been assigned the appropriate status corresponding the code or message in the reply message.

43. The method of claim 35, further comprising a method for checking a setup parameter to determine whether the sender wishes to have P-O-R reply messages containing negative feedback printed upon receipt, and if so, to format and print said message at the sender's station, on the default or P-O-R designated printer.

44. The method of claim 35, further comprising a method for storing a configurable parameter, and providing a user interface to set and un-set said parameter that informs the sending e-mail program that a selected contact (i.e. address book entry or e-mail address) does not accept P-O-R requests.

45. The method of claim 35, further comprising a method for checking, when the sender includes a P-O-R request while composing an outgoing e-mail message, a setup parameter in the contact record (i.e. address book entry) for the receiver to whom the message is addressed, to determine if the receiver does not accept P-O-R requests, and if so to display a warning message to the sender, and optionally, to remove the P-O-R request from the outgoing message.

46. The method of claim 35, further comprising a method for using a message property (such as the Importance field) that exists in the industry standard (such as SMTP) e-mail message header to store a code to indicate a P-O-R request.

47. The method of claim 35, further comprising a method for using the status field in the sent e-mail list filed on the sender's system, to store a code or icon to indicate that a P-O-R request is pending acknowledgement, that the waiting time has expired, that the message (and optional attachments) were successfully printed or, if not, an appropriate error code or icon.

48. The method of claim 35, further comprising a method for the sending e-mail program to automatically calculate the size (in pages) of the outgoing P-O-R message and its optional attachment files, and further, to insert the calculated number of pages in a specially designated data field in the e-mail header portion of the e-mail message.

49. The method of claim 34, further comprising a method for the sending e-mail program to automatically calculate the size (in bytes) of the outgoing P-O-R message and its optional attachment files, and further, inserting the calculated number of bytes in a specially designated data field in the e-mail header portion of the e-mail message.

50. The method of claim 35, wherein the sending e-mail program, upon receiving a P-O-R reply message indicating that the receiver does not accept P-O-R requests, updates the setup parameter in the contact record (or address book entry) for the receiver to indicate that the contact does not accept P-O-R requests.

51. The method of claim 35, wherein the sending e-mail system is a computer application other than an e-mail program that automatically generates and sends P-O-R e-mail, including without limitation: accounting systems, e-mail fax delivery systems, and pathology laboratory results distribution systems.
